(19) United States
(12) Patent Application Publication
(10) Pub. No.: US 2026/0089471 A1
(43) Pub. Date: Mar. 26, 2026

(54) System and Method for Managing a Recharge Session for an Electric-Vehicle (EV) Battery

(71) Applicant: EnerSys Delaware Inc., Reading, PA (US)

(72) Inventors: Fabrice Tran-Xuan, Arras (FR); Jean-Baptiste Duchene, Arras (FR); Thomas Dupont, Arras (FR); Remi Dhamelincourt, Arras (FR)

(21) Appl. No.: 18/892,807

(22) Filed: Sep. 23, 2024

(51) Int. Cl. H04W 4/14; B60L 53/30; B60L 53/66; G06K 19/06; H04W 12/03

(52) U.S. Cl. CPC H04W 4/14; B60L 53/305; B60L 53/66; G06K 19/06037; H04W 12/03

(57) ABSTRACT

Embodiments are directed towards a computer-implemented method for managing a recharge session for an electric vehicle (EV) battery is provided. The method may include encrypting a session identifier, embedding the encrypted session identifier into a text message, and encoding the text message into a scannable QR code. In response to scanning the QR code, the method may cause the text message to be decoded on an end-user device. The method may cause a messaging app on the end-user device to automatically open with a predetermined recipient address and a message body pre-populated with the decoded text message. The method may further cause the decoded text message to be stored on one or more cloud-based servers. The method may also include extracting the encrypted session identifier from the decoded text message, decrypting the session identifier embedded in the text message, and obtaining session information based on the decrypted session identifier.

### BACKGROUND

Most outdoor kiosks may require customers to manually input personal information, such as email addresses, phone numbers, etc. in order to establish communication with an end user and to be able to provide notifications, share documents, receive queries, etc. Most outdoor kiosks may not include built-in printers to provide print-outs and instead may rely on the use of digital documents sent via email, or short-message service (SMS) text messages. To manually input personal information, customers (end users) may input their contact information through a human-machine interface (HMI) displayed on a touchscreen. This method may be error-prone and may not be reliable, because human error may cause end users to enter incorrect information, or to accidentally mistype the information without realizing their mistake. Moreover, such a method of data input may not work in environments with hard winters, because freezing rain may make the use of a touchscreen very difficult and impractical.

### SUMMARY

In one or more embodiments of the present disclosure, a computer-implemented method for managing a recharge session for an electric vehicle (EV) battery is provided. The method may include encrypting a session identifier, embedding the encrypted session identifier into a text message, and encoding the text message into a scannable QR code. In response to scanning the QR code, the method may cause the text message to be decoded on an end-user device. In response to decoding the text message, the method may cause a messaging app on the end-user device to automatically open with a predetermined recipient address and a message body pre-populated with the decoded text message. In response to sending the decoded text message to the predetermined recipient address, the method may receive and store the decoded text message on one or more cloud-based servers. The method may also include extracting the encrypted session identifier from the decoded text message, decrypting the session identifier embedded in the text message, and obtaining session information based on the decrypted session identifier. The method may further include generating and sending one or more messages to the end-user device via the messaging app based on the obtained session information, and deleting the stored decoded text message from the one or more cloud-based servers.

One or more of the following features may be included. The messaging app may be at least one of an email app or a short-messaging-service (SMS) app. In response to the text message starting with a first predetermined string of text, the end user-device automatically may open an email messaging app. In response to the message text starting with a second predetermined string of text, the end user-device automatically may open a short-messaging-service (SMS) messaging app. The predetermined recipient address may direct a message to one or more cloud-based servers configured to run a message collector service. The one or more cloud-based servers may include an artificial intelligence (AI) text analyzer configured to extract the encrypted session identifier from the decoded text message. The one or more messages sent to the end-user device may include at least one of: an acknowledgment of receipt of the initial message sent from the end-user device, a progress update on the level of charge of the EV battery, an emergency stop notification, a link to a web-based summary of the recharge session, a receipt, and a notification of non-compliance and additional fees. The predetermined recipient address may be one of at least a unique phone number, or a unique email address. The one or more cloud-based servers may host a secured document database configured to temporarily store the decoded text message. The decoded text message may be stored before the encrypted session identifier may be decrypted, such that all session identifiers stored in the secured document database are encrypted for the duration of storage.

In another embodiment of the present disclosure, a system for managing a recharge session for an electric vehicle (EV) battery is provided. The system may include a kiosk including a graphical user interface and at least one processor configured to execute one or more operations. The operations may include encrypting a session identifier, embedding the encrypted session identifier into a text message, and encoding the text message into a scannable QR code. In response to scanning the QR code, the operations may cause the text message to be decoded on an end-user device. In response to decoding the text message, the operations may cause a messaging app on the end-user device to automatically open with a predetermined recipient address and a message body pre-populated with the decoded text message. In response to sending the decoded text message to the predetermined recipient address, the operations may receive and store the decoded text message on one or more cloud-based servers. The operations may also include extracting the encrypted session identifier from the decoded text message, decrypting the session identifier embedded in the text message, and obtaining session information based on the decrypted session identifier. The operations may further include generating and sending one or more messages to the end-user device via the messaging app based on the obtained session information, and deleting the stored decoded text message from the one or more cloud-based servers.

One or more of the following features may be included. The messaging app may be at least one of an email app or a short-messaging-service (SMS) app. In response to the text message starting with a first predetermined string of text, the end user-device automatically may open an email messaging app. In response to the message text starting with a second predetermined string of text, the end user-device automatically may open a short-messaging-service (SMS) messaging app. The predetermined recipient address may direct a message to one or more cloud-based servers configured to run a message collector service. The one or more cloud-based servers may include an artificial intelligence (AI) text analyzer configured to extract the encrypted session identifier from the decoded text message. The one or more messages sent to the end-user device may include at least one of: an acknowledgment of receipt of the initial message sent from the end-user device, a progress update on the level of charge of the EV battery, an emergency stop notification, a link to a web-based summary of the recharge session, a receipt, and a notification of non-compliance and additional fees. The one or more cloud-based servers may host a secured document database configured to temporarily store the decoded text message. The decoded text message may be stored before the encrypted session identifier may be decrypted, such that all session identifiers stored in the secured document database are encrypted for the duration of storage. The predetermined recipient address may be one of at least a unique phone number, or a unique email address.

Additional features and advantages of embodiments of the present disclosure will be set forth in the description that follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts a session management process coupled to a distributed computing network;

FIG. 2 diagrammatically depicts an example of a basic social interaction between people;

FIG. 3 diagrammatically depicts an example of a computer-implemented reproduction of the social interaction in FIG. 2;

FIG. 4 diagrammatically depicts an example of an SMS initialization of the session management process for recharging an electric vehicle (EV) battery, in accordance with embodiments of the present disclosure;

FIG. 5 diagrammatically depicts an example of an email initialization of the session management process for recharging an electric vehicle (EV) battery, in accordance with embodiments of the present disclosure;

FIG. 6 diagrammatically depicts an example of a cloud-based portion of the session management process for recharging an electric vehicle (EV) battery, in accordance with embodiments of the present disclosure;

FIG. 7 diagrammatically depicts an example of an SMS finalization of the session management process for recharging an electric vehicle (EV) battery, in accordance with embodiments of the present disclosure;

FIG. 8 diagrammatically depicts an example of an email finalization of the session management process for recharging an electric vehicle (EV) battery, in accordance with embodiments of the present disclosure; and

FIG. 9 shows an exemplary flowchart of a session management process for recharging an electric vehicle (EV) battery, in accordance with embodiments of the present disclosure.

### DETAILED DESCRIPTION

Autonomous charging stations for electric-vehicle (EV) batteries may require a mechanism for end users to interact directly with whatever entity provides the recharging service. The end user may need to establish communication with the service provider in order to request the service, submit payment, receive notifications, make changes to the requested service, etc. A kiosk may be a tool well suited for these purposes, but they come with the implicit requirement that the end user be physically present at the location of the kiosk to manually enter information to be submitted. For example, the end user may need to provide a contact number or email address by manually typing the information using a keyboard or touchscreen interface at the site of the kiosk. Once the end user information is received a unique session identifier may be generated, which may then be used to organize and facilitate every aspect of the EV recharging session. For example, the session identifier may be used to keep track of: (i) the percentage charge remaining in the EV battery, (ii) the time remaining in the EV recharging session, (iii) the time for which the EV charging station may be occupied in excess of the EV recharging session, (iv) the time of day and corresponding price of electricity based on demand, etc. Here, the EV recharging session may refer to the period of time for which the customer (end-user) engages the service provider and any services provided to the customer during that time.

Organizing the interactions between the end user and the service provider through the framework of the EV recharging session may facilitate more effective communication between the two parties on an ongoing basis. For example, the service provider may send progress updates to the end user at predetermined increments of remaining charge throughout the session, or the end user may wish to reduce or extend the duration of the session unexpectedly, or an error may occur during the session and the service provider may wish to update the end user so that remedial action can be taken. Each of the preceding examples may illustrate the convenience and importance of establishing and maintaining open lines of communication between the end user and the service provider. However, the conventional means of manually entering information at a kiosk may be prone to human error and therefore may be unreliable. Human error may cause end users to intentionally enter incorrect information that they mistakenly believe to be correct or to unintentionally enter incorrect information without realizing their mistake. Moreover, such a method of data input may not work in environments with hard winters, because freezing rain may make the use of a touchscreen very difficult and impractical.

With those considerations in mind, the goal of the invention disclosed herein may be to provide a convenient and simple process for establishing communication with end users to more effectively manage the EV recharging session, while also reducing the risk of user error. Moreover, the process disclosed herein may work with any smartphone having a camera (IOS, Android, etc.) and may not require the installation of a third-party application.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

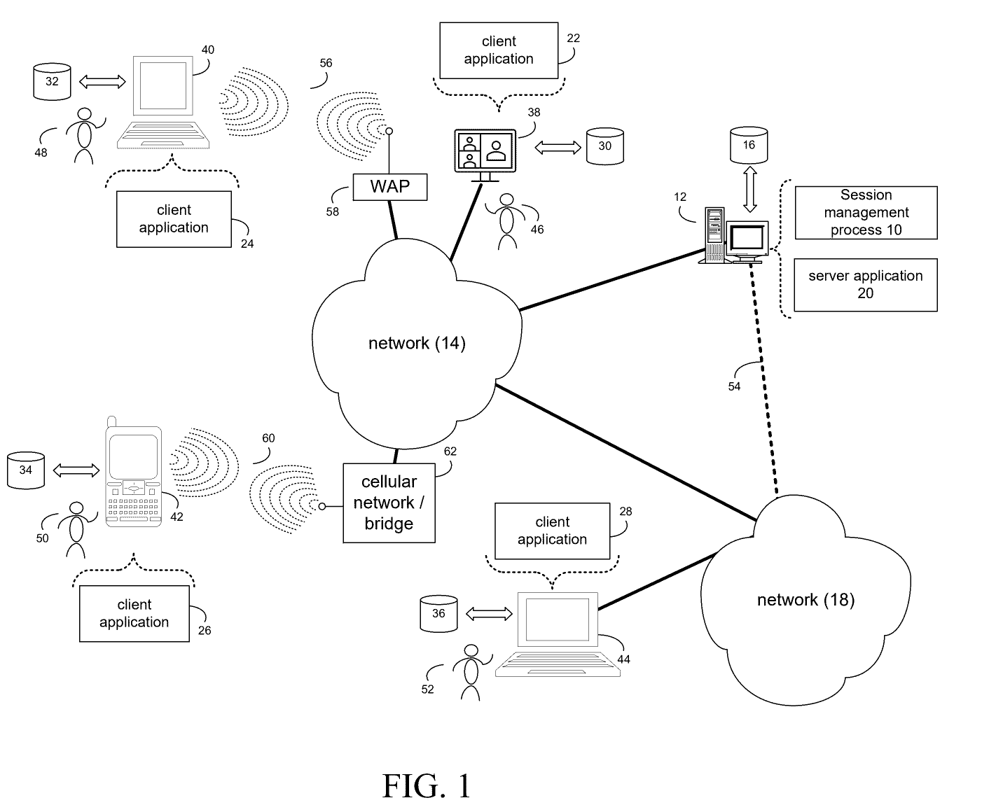

Referring to FIG. 1, there is shown session management process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally and/or alternatively, the routing topology process may reside on a client electronic device, such as a personal computer, notebook computer, personal digital assistant, or the like.

The instruction sets and subroutines of the session management process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server, etc. Server application 20 may interact with one or more client applications (e.g., client applications 22, 24, 26, 28) in order to execute session management process 10. Examples of client applications 22, 24, 26, 28 may include, but are not limited to, EDAs or design verification tools such as those available from the assignee of the present disclosure. These applications may also be executed by server computer 12. In some embodiments, session management process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, session management process 10 may be a client-side application residing on one or more client electronic devices 38, 40, 42, 44 (e.g., stored on storage devices 30, 32, 34, 36, respectively). As such, session management process 10 may be a stand-alone application that interfaces with a client application (e.g., client applications 22, 24, 26, 28), or may be applets/applications that may be executed within a client application. As such, session management process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, kiosk 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, session management process 10 may be a cloud-based process as any or all of the operations described herein may occur, in whole, or in part, in the cloud or as part of a cloud-based system. The various client electronic devices may be directly or indirectly coupled to network 14 (or network 18). For example, kiosk 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple IOS, ANDROID, or a custom operating system.

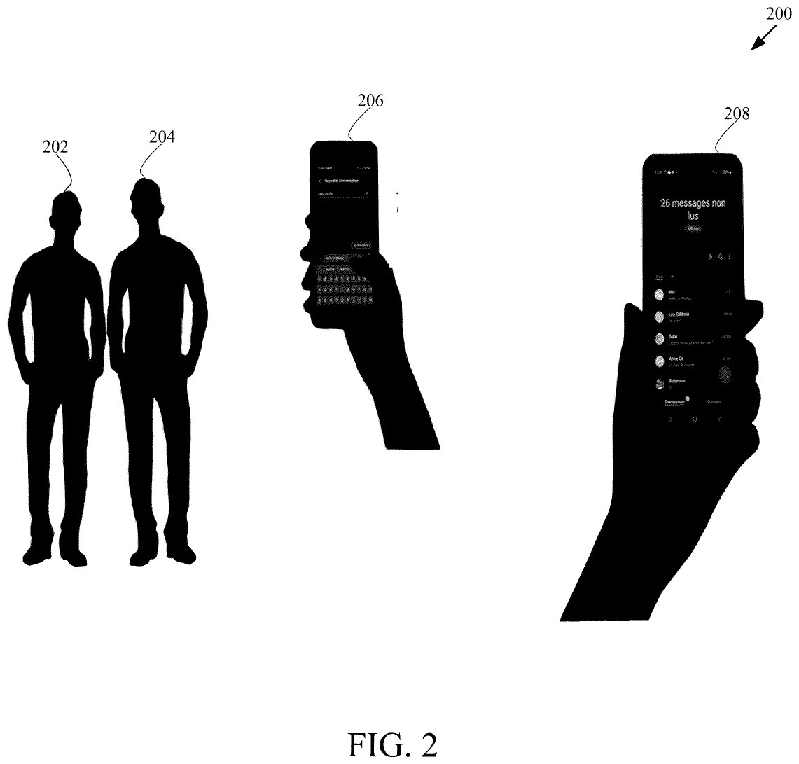

Referring now to FIG. 2, an example 200 of a basic social interaction between people is provided. Example 200 illustrates a common social interaction between two people, where they exchange contact information. Initially, first person 202 may take the contact information of second person 204, whether that be a phone number, email address, social media contact, etc., and may then enter the contact information of second person 204 into first user device 206 belonging to first person 202. Once entered, first person 202 may then use a messaging app (such as the short-messaging service {SMS}) to send a message to second person 204. Once second person 204 receives the message sent by first person 202, second person 204 may then save the contact information of the sender (first person 202) into second user device 208 belonging to second person 204 without having to manually enter the characters into the device. In example 200, first person 202 may still manually enter the contact information of second person 204, which may introduce the risk of human error. However, in example 200 the negative effects of human error may be reduced by the presence of second person 204 who may provide immediate feedback in the event of an error, where the feedback may be able to immediately correct the error.

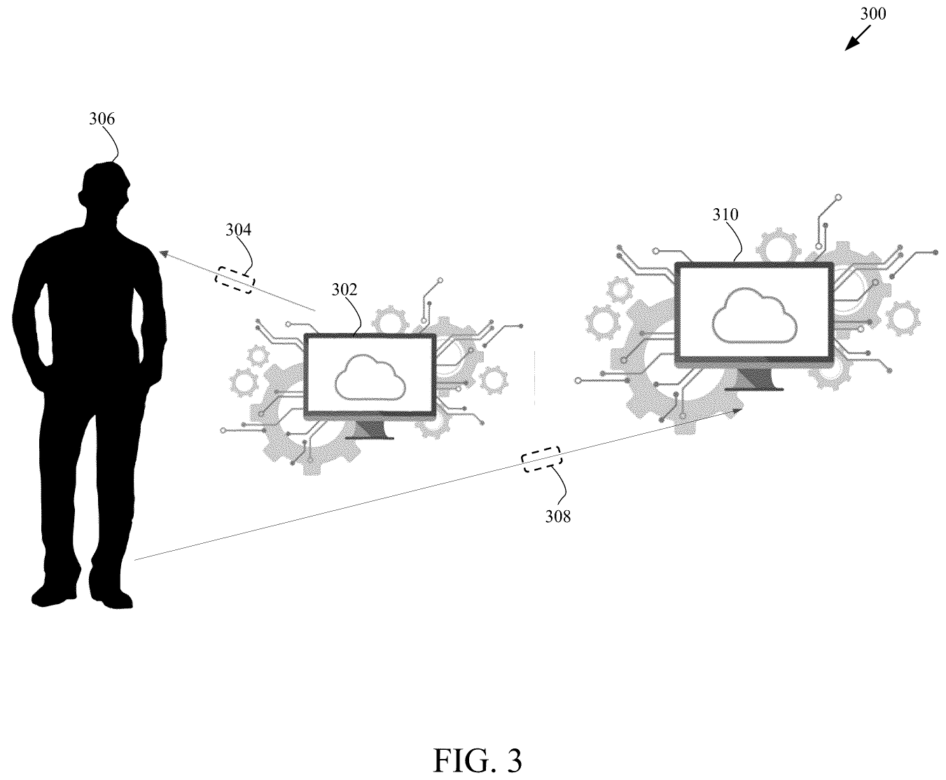

Referring now to FIG. 3, an example 300 of a computer-implemented reproduction of the social interaction shown in example 200 is provided. Example 300 may apply the same approach as shown in example 200, but without introducing the risk of human error. Instead of first person 202 having to manually enter the contact information of second person 204, computer 302, in the form of a kiosk, may transmit message template 304 addressed to a recipient address controlled by a service provider directly into end-user device, such that the end user 306 may never have an opportunity to manually enter the recipient's contact information. A messaging app may be automatically opened on the end-user device with the recipient field pre-populated with a predetermined recipient address, such that the end user may need only “press send” to transmit reply 308 from the end-user device to the service provider. Then, like second person 204 in example 200, the service provider may use one or more cloud-based servers 310 to receive reply 308 from the end-user device and obtain the contact information of the sender without a human having to manually enter any characters into a device.

In some embodiments, in order to transmit message template 304 directly into an end-user device computer 302 in the form of a kiosk may include a display screen configured to show a quick-response (QR) code. Then a prospective customer (end-user 306) may use an end-user device, such as a smartphone equipped with a camera, to scan the QR code. After being scanned, the QR code may be configured to open a messaging app, such as SMS or email, with the recipient field pre-populated with a phone number or email address controlled by the service provider, and may optionally include a text message in the body portion of the message.

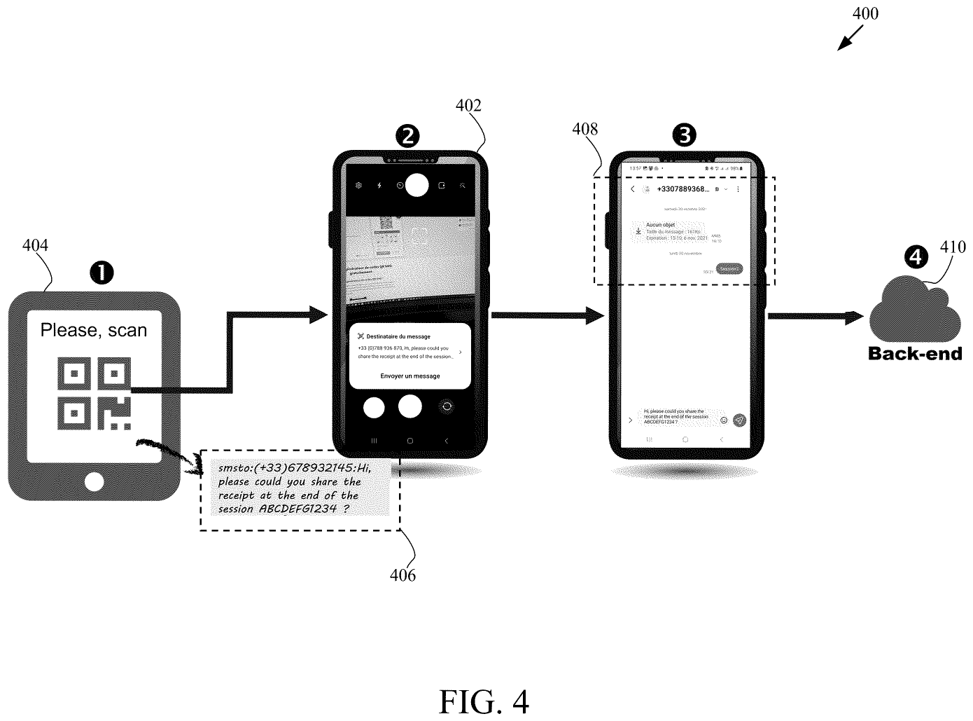

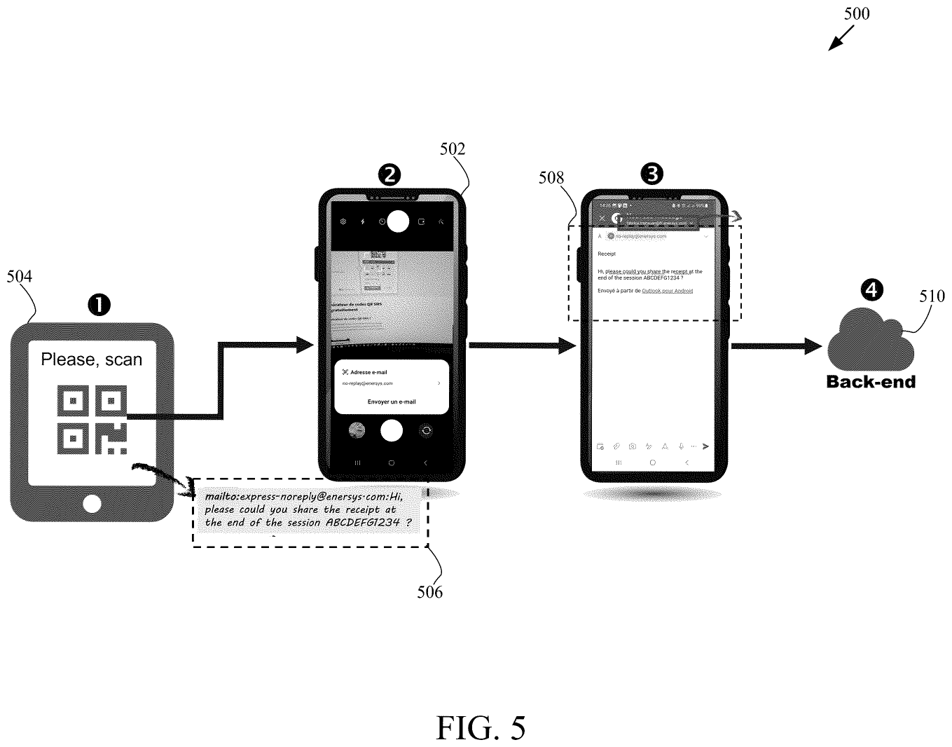

Referring now to FIGS. 4 and 5, example 400 depicting an email initialization of the session management process for recharging an electric vehicle (EV) battery, and example 500 depicting a cloud-based portion of the session management process for recharging an electric vehicle (EV) battery are provided. Both examples 400, 500 may involve the same elements with the only difference being the nature of the messaging app being used to send the message. In both examples 400, 500 initialization of the session management process may begin by using a camera-equipped smartphone 402, 502 to scan a QR code from a display screen 404, 504, such as a kiosk. In example 400 the encoded message template 406 may begin with the term “smsto:” which may prompt the end user-device (smartphone) to automatically open an SMS messaging app 408 with a predetermined phone number controlled by the service provider recipient field, and a pre-populated text message in the body of the message. Similarly, in example 500 the encoded message template 506 may begin with the term “emailto:” which may prompt the end user-device (smartphone) to automatically open an email messaging app 508 with a predetermined email address controlled by the service provider in the recipient field, and a pre-populated text message in the body of the message. After opening the appropriate messaging app, both examples 400, 500 show where an end user may send a message to the service provider without having to manually enter a phone number or email address into the recipient field. Once sent both examples 400, 500 show where cloud-based resources 410, 510 may be used to receive and process the message.

In some embodiments, the prepopulated text message may also include an encrypted form of a session identifier, which as previously mentioned may be used to organize and facilitate every aspect of the EV recharging session. As such, the most critical information may remain confidential and secure on both the end-user device and on the cloud-based resources used to receive the initialization message.

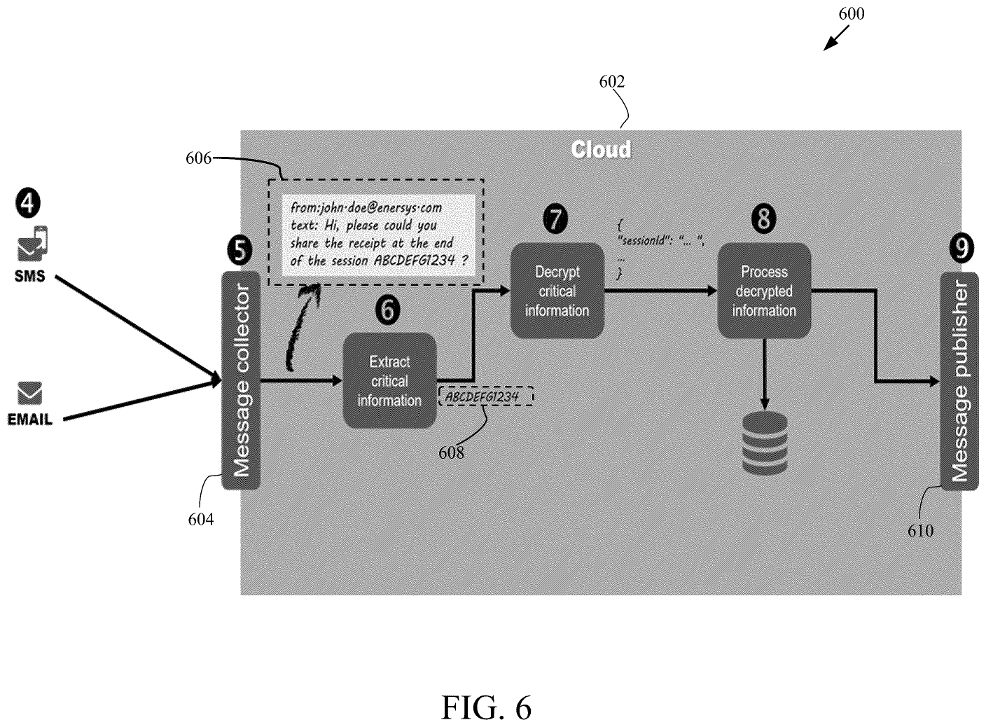

Referring now to FIG. 6 an example 600 depicting a cloud-based portion of the session management process for recharging an electric vehicle (EV) battery is provided. Example 600 shows where one or more cloud-based servers 602 may include a message collector 604 configured to receive an incoming message 606 from an end user device in the form of either an SMS message or an email message. The incoming message 606 may also include an encrypted form of session identifier 608. The one or more cloud-based servers 602 may also include an artificial intelligence (AI) text analyzer 610 configured to extract the encrypted session identifier 608 from the incoming message 606. The one or more cloud-based servers 602 may also include a decoder configured to decrypt session identifier 608. Once decrypted, session identifier 608 may then be further processed, for example, decrypted session identifier 608 may be used to organize and facilitate various aspects of the EV recharging session, including but not limited to keeping track of: (i) the percentage charge remaining in the EV battery, (ii) the time remaining in the EV recharging session, (iii) the time for which the EV charging station may be occupied in excess of the EV recharging session, (iv) the time of day and corresponding price of electricity based on demand, etc. Here, the EV recharging session may refer to the period of time for which the customer (end-user) engages the service provider and any services provided to the customer during that time. Once processed, message publisher 610 may be configured to generate and transmit any further notifications or other messages that may need to be sent out to the end user.

In some embodiments, the ID of the session may be a base64 encoded structured content. Once base64 decoded, this content may be a binary one encoded using a decoder. By using the decoder, it may possible to get access to a data structure that may contain all the relevant information for the process, for example: ID of the transaction, EV's driver phone number, etc. Moreover, additional information may be added: for instance the charger may generate a random PIN code to lock the session. Further, when the content is decoded, the ID of the transaction may be used to associate the phone number of the EV driver to the session. This phone number may be used during the whole session to share information with the EV driver, such as: the state of charge, stopped charge, issue, final price, etc. For instance, this phone number may be used to send an SMS to the EV driver with a link to download a mirroring application for smartphone, with the PIN code to use on the charger to unlock a session. Further, when the charge is over, this phone number may be deleted to be compliant with the GDPR.

In some embodiments, the contact information obtained from the sender (email or phone number) may be extracted and safely re-used, because the application on the end-user device may grant permission. The one or more cloud-based servers 602 may host a secured document database configured to temporarily store the obtained information for re-use at the end of the transaction. The obtained information may be stored securely in a temporary database and then may be deleted at the end of the transaction after sending a final notification or message to the end user, such as a receipt. In this way, the service provider may remain compliant with the general data protection regulation (GDPR) laws. The decoded text message may be stored before the encrypted session identifier is decrypted, such that all session identifiers stored in the secured document database may remain encrypted for the duration of storage.

In some embodiments, the further notifications or other messages generated and transmitted by message publisher 610 may include but are not limited to: an acknowledgment of receipt of the initial message sent from the end-user device, a progress update on the level of charge of the EV battery, an emergency stop notification; a link to a web-based summary of the recharge session, a receipt, and a notification of non-compliance and additional fees.

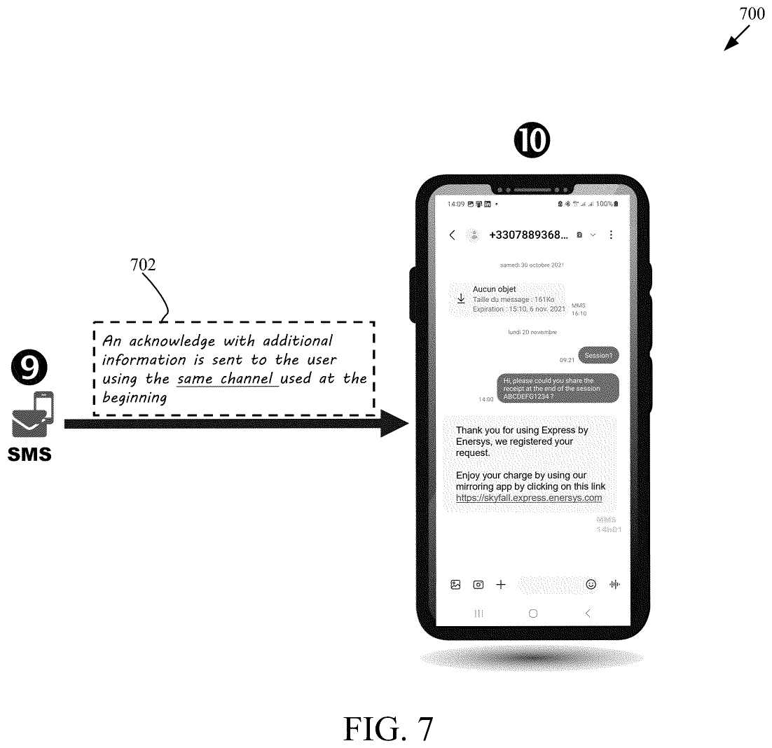

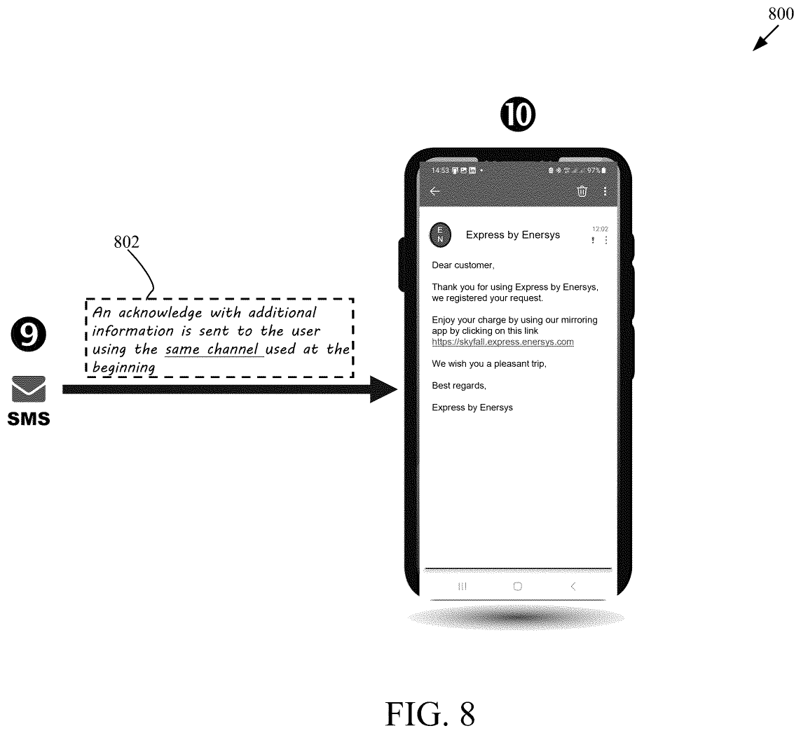

Referring now to FIGS. 7 and 8 an example 700 depicting a SMS finalization of the session management process for recharging an electric-vehicle (EV) battery, and an example 800 depicting an email finalization of the session management process for recharging an electric-vehicle (EV) battery are provided. Both examples 700, 800 may involve the same elements with the only difference being the nature of the messaging app being used to send the message. In both examples 700, 800, the message publisher 610 may send an acknowledgment message 702, 802, in the same messaging app used to send the initialization message, such that the mode of communication may be consistent throughout the session. The acknowledgement message 702, 802 may provide the end user with a link that may be used to monitor the progress of the EV battery recharge session.

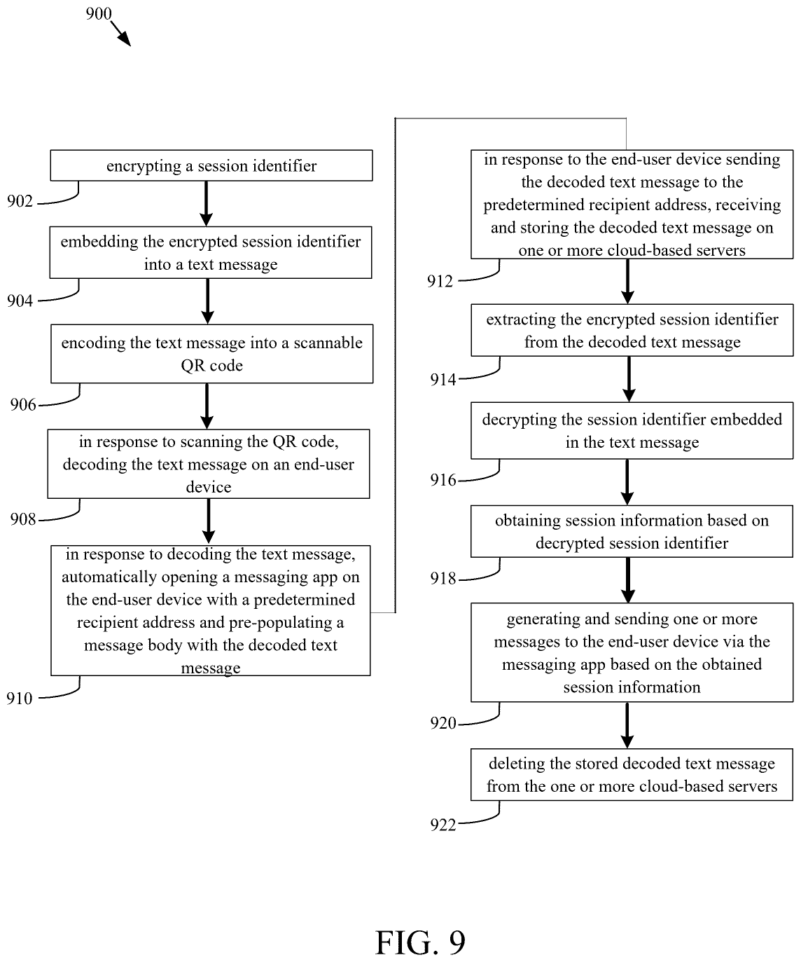

Referring now to FIG. 9 a flowchart 900 depicting the session management process 10 for recharging an electric-vehicle (EV) battery is provided. Session management process 10 may include encrypting (902) a session identifier, embedding (904) the encrypted session identifier into a text message, and encoding (906) the text message into a scannable QR code. In response to scanning the QR code, session management process 10 may include decoding (908) the text message on an end-user device. In response to decoding the text message, session management process 10 may include automatically opening (910) a messaging app on the end-user device with a predetermined recipient address and pre-populating a message body with the decoded text message. In response to the end-user device sending the decoded text message to the predetermined recipient address, session management process 10 may further include storing (912) the decoded text message on one or more cloud-based servers. Session management process 10 may also include extracting (914) the encrypted session identifier from the decoded text message, decrypting (916) the session identifier embedded in the text message, and obtaining (918) session information based on the decrypted session identifier. Session management process 10 may further include generating (920) and sending one or more messages to the end-user device via the messaging app based on the obtained session information, and deleting (922) the stored decoded text message from the one or more cloud-based servers.

It will be apparent to those skilled in the art that various modifications and variations can be made to session management process 10 and/or embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A computer implemented method, for managing a recharge session for an electric vehicle (EV) battery, the method comprising:
encrypting a session identifier;
embedding the encrypted session identifier into a text message;
encoding the text message into a scannable QR code;
in response to scanning the QR code, causing the text message to be decoded on an end-user device;
in response to decoding the text message, causing a messaging app on the end-user device to automatically open with a predetermined recipient address and a message body pre-populated with the decoded text message;
in response to sending the decoded text message to the predetermined recipient address, receiving and storing the decoded text message on one or more cloud-based servers;
extracting the encrypted session identifier from the decoded text message;
decrypting the session identifier embedded in the text message;
obtaining session information based on decrypted session identifier;
generating and sending one or more messages to the end-user device via the messaging app based on the obtained session information; and
deleting the stored decoded text message from the one or more cloud-based servers.

2. The computer-implemented method of claim 1, wherein the messaging app is at least one of an email app or a short-messaging-service (SMS) app.

3. The computer-implemented method of claim 2, wherein in response to the text message starting with a first predetermined string of text, the end user-device automatically opens an email messaging app.

4. The computer-implemented method of claim 2, wherein in response to the message text starting with a second predetermined string of text, the end user-device automatically opens an SMS messaging app.

5. The computer-implemented method of claim 1, wherein the predetermined recipient address directs a message to one or more cloud-based servers configured to run a message collector service.

6. The computer-implemented method of claim 1, wherein the one or more cloud-based servers include an artificial intelligence (AI) text analyzer configured to extract the encrypted session identifier from the decoded text message.

7. The computer-implemented method of claim 1, wherein the one or more messages sent to the end-user device include at least one of:
an acknowledgment of receipt of the initial message sent from the end user device;
a progress update on the level of charge of the EV battery;
an emergency stop notification;
a link to a web-based summary of the recharge session;
a receipt; and
a notification of non-compliance and additional fees.

8. The computer-implemented method of claim 1, wherein the predetermined recipient address is one of at least a unique phone number, or a unique email address.

9. The computer-implemented method of claim 1, wherein the one or more cloud-based servers host a secured document database configured to temporarily store the decoded text message.

10. The computer-implemented method of claim 1, wherein the decoded text message is stored before the encrypted session identifier is decrypted, such that all session identifiers stored in the secured document database are encrypted for the duration of storage.

11. A system, for managing a recharge session for an electric vehicle (EV) battery, the system comprising:
a kiosk including a graphical user interface; and
at least one processor configured to execute one or more operations, the operations comprising:
encrypting a session identifier;
embedding the encrypted session identifier into a text message;
encoding the text message into a scannable QR code;
in response to scanning the QR code, causing the text message to be decoded on an end-user device;
in response to decoding the text message, causing a messaging app on the end-user device to automatically open with a predetermined recipient address and a message body pre-populated with the decoded text message;
in response to sending the decoded text message to the predetermined recipient address, receiving and storing the decoded text message on one or more cloud-based servers;
extracting the encrypted session identifier from the decoded text message;
decrypting the session identifier embedded in the text message;
obtaining session information based on decrypted session identifier;
generating and sending one or more messages to the end-user device via the messaging app based on the obtained session information; and
deleting the stored decoded text message from the one or more cloud-based servers.

12. The system of claim 11, wherein the messaging app is at least one of an email app or a short-messaging-service (SMS) app.

13. The system of claim 12, wherein in response to the text message starting with a first predetermined string of text, the end user-device automatically opens an email messaging app.

14. The system of claim 12, wherein in response to the message text starting with a second predetermined string of text, the end user-device automatically opens an SMS messaging app.

15. The system of claim 11, wherein the predetermined recipient address directs a message to one or more cloud-based servers configured to run a message collector service.

16. The system of claim 11, wherein the one or more cloud-based servers include an artificial intelligence (AI) text analyzer configured to extract the session identifier from the decoded text message.

17. The system of claim 11, wherein the one or more messages sent to the end-user device include at least one of:
an acknowledgment of receipt of the initial message sent from the end user device,
a progress update on the level of charge of the EV battery,
an emergency stop notification,
a link to a web-based summary of the recharge session,
a receipt, and
a notification of non-compliance and additional fees.

18. The system of claim 11, wherein the one or more cloud-based servers host a secured document database configured to store the decoded text message with the encrypted session identifier.

19. The system of claim 11, wherein the decoded text message is stored before the encrypted session identifier is decrypted, such that all session identifiers stored in the secured document database are encrypted for the duration of storage.

20. The system of claim 11, wherein the predetermined recipient address is one of at least a unique phone number, or a unique email address.
